(19) United States
(12) Patent Application Publication
(10) Pub. No.: US 2023/0242153 A1
(43) Pub. Date: Aug. 3, 2023

(54) CUSTOMIZATION AND SAFETY VERIFICATION OF AUTONOMOUS VEHICLE DRIVING BEHAVIOR

(71) Applicant: GM Cruise Holdings LLC, San Francisco, CA (US)

(72) Inventor: Burkay Donderici, Burlingame, CA (US)

(21) Appl. No.: 17/588,821

(22) Filed: Jan. 31, 2022

(51) Int. Cl. B60W 60/00; B60W 40/09; B60W 50/00; B60W 50/10; B60W 50/14

(52) U.S. Cl. CPC B60W 60/0016; B60W 60/0018; B60W 40/09; B60W 50/0097; B60W 50/0098; B60W 50/10; B60W 50/14; B60W 2400/00; B60W 2540/215; B60W 2756/00

(57) ABSTRACT

The present technology is directed to customizing a driving behavior of an autonomous vehicle (AV) and verifying safety of the driving behavior based on a simulation. An AV management system can determine driving parameter(s) relating to a driving behavior of an AV and determine a degree of similarity between the driving parameters and a plurality of stored driving parameters. Based on a determination that the degree of the similarity is outside of a predetermined range, the AV management system can generate a scenario to test a safety of the driving parameters, perform a simulation of the AV in the scenario, and compare a simulation result with a predetermined safety threshold. Based on a determination that the simulation result is equal to or above the predetermined safety threshold, the AV management system can adjust the driving behavior of the AV based on the driving parameters.

### TECHNICAL FIELD

The subject matter of this disclosure relates in general to the field of an autonomous vehicle (AV) management system, and more particularly, to solutions for customizing an AV driving behavior and verifying the safety of the driving behavior based on a simulation.

### BACKGROUND

Autonomous vehicles (AVs) have computers and control systems that perform driving and navigation tasks that are conventionally performed by a human driver. As AV technologies continue to advance, a real-world simulation for AV testing has been important in improving the safety and efficiency of AV driving. An exemplary AV can include various sensors, such as a camera sensor, a Light Detection and Ranging (LiDAR) sensor, a Radio Detection and Ranging (RADAR) sensor, and software for interpreting data received from the sensors. Collectively, these sensors and software can be used to allow an AV to pilot itself.

### BRIEF DESCRIPTION OF THE DRAWINGS

Illustrative embodiments of the present application are described in detail below with reference to the following figures:

FIG. 1 illustrates an example of a system for managing one or more Autonomous Vehicles (AVs) in accordance with some examples of the present disclosure.

FIG. 2 illustrates an example of an AV control system for customizing an AV driving behavior and verifying the safety of the driving behavior based on a simulation in accordance with some examples of the present disclosure.

FIG. 3 illustrates a flowchart of a method for verifying the safety of an AV driving behavior based on a simulation in accordance with some examples of the present disclosure.

FIG. 4 illustrates an example network device in accordance with some examples of the present disclosure.

### SUMMARY

According to at least one example of the present technology, an AV management system can determine one or more driving parameters for an AV where the one or more driving parameters relating to a driving behavior of the AV and determine a degree of similarity between the one or more driving parameters and a plurality of stored driving parameters. Based on a determination that the degree of the similarity is outside of a predetermined range, the AV management system can generate a scenario to test a safety of the one or more driving parameters, perform a simulation of the AV in the scenario to test the safety of the one or more driving parameters, and compare a simulation result with a predetermined safety threshold. Based on a determination that the simulation result is equal to or above the predetermined safety threshold, the AV management system can adjust the driving behavior of the AV based on the one or more driving parameters.

A system for customizing an AV driving behavior and verifying the safety of the driving behavior based on a simulation can include one or more processors and at least one computer-readable storage medium storing instructions which, when executed by the one or more processors, cause the one or more processors to determine one or more driving parameters for an AV where the one or more driving parameters relating to a driving behavior of the AV and determine a degree of similarity between the one or more driving parameters and a plurality of stored driving parameters. Furthermore, the instructions can cause the one or more processors to generate a scenario to test a safety of the one or more driving parameters based on a determination that the degree of the similarity is outside of a predetermined range, perform a simulation of the AV in the scenario to test the safety of the one or more driving parameters, and compare a simulation result with a predetermined safety threshold. Also, the instructions can cause the one or more processors to adjust the driving behavior of the AV based on the one or more driving parameters based on a determination that the simulation result is equal to or above the predetermined safety threshold.

A non-transitory computer-readable storage medium having stored therein instructions which, when executed by one or more processors, can cause the one or more processors to determine one or more driving parameters for an AV where the one or more driving parameters relating to a driving behavior of the AV and determine a degree of similarity between the one or more driving parameters and a plurality of stored driving parameters. Furthermore, the instructions can cause the one or more processors to generate a scenario to test a safety of the one or more driving parameters based on a determination that the degree of the similarity is outside of a predetermined range, perform a simulation of the AV in the scenario to test the safety of the one or more driving parameters, and compare a simulation result with a predetermined safety threshold. Also, the instructions can cause the one or more processors to adjust the driving behavior of the AV based on the one or more driving parameters based on a determination that the simulation result is equal to or above the predetermined safety threshold.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for the convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

A control system in AVs aims to achieve vehicle automation with a bare minimum input or control from a human driver or passenger. To enable the automated operation, AVs can be configured to adhere to pre-programmed driving behavior that suits the preferences of the general public within a safety-verified manner. If a human passenger is not in full control of the vehicle, the passenger at least may want the vehicle to behave in the passenger's preferred way. For example, different passengers may have different desired driving behaviors such as aggressive vs. defensive or comfort vs. sporty styles. A passenger also may desire different driving styles depending on one or more factors such as, for example, weather conditions, road conditions, scheduling conditions, one or more events, and/or any other factors.

Furthermore, for the safe and efficient operation of AVs, any type of driving behavior should be within a safety- and comfort-ensuring manner. If a human passenger is allowed to modify the pre-programmed driving behavior or driving characteristics, the modified behavior and characteristics need to be validated, prior to initiating the operation of the AV, to ensure that the AV operation based on the modification is within safety standards.

Therefore, there exists a need for an AV management system that enables customization of driving behavior, more specifically based on passenger preferences. There is also a strong need for an AV management system that validates the safety of the customized driving behavior based on a simulation. The present technology includes systems, methods, and computer-readable media for solving the foregoing problems and discrepancies, among others. In some examples, systems, methods, and computer-readable media are provided for customization of an AV driving behavior (i.e., operational behavior) and safety verification for the driving behavior based on a simulation.

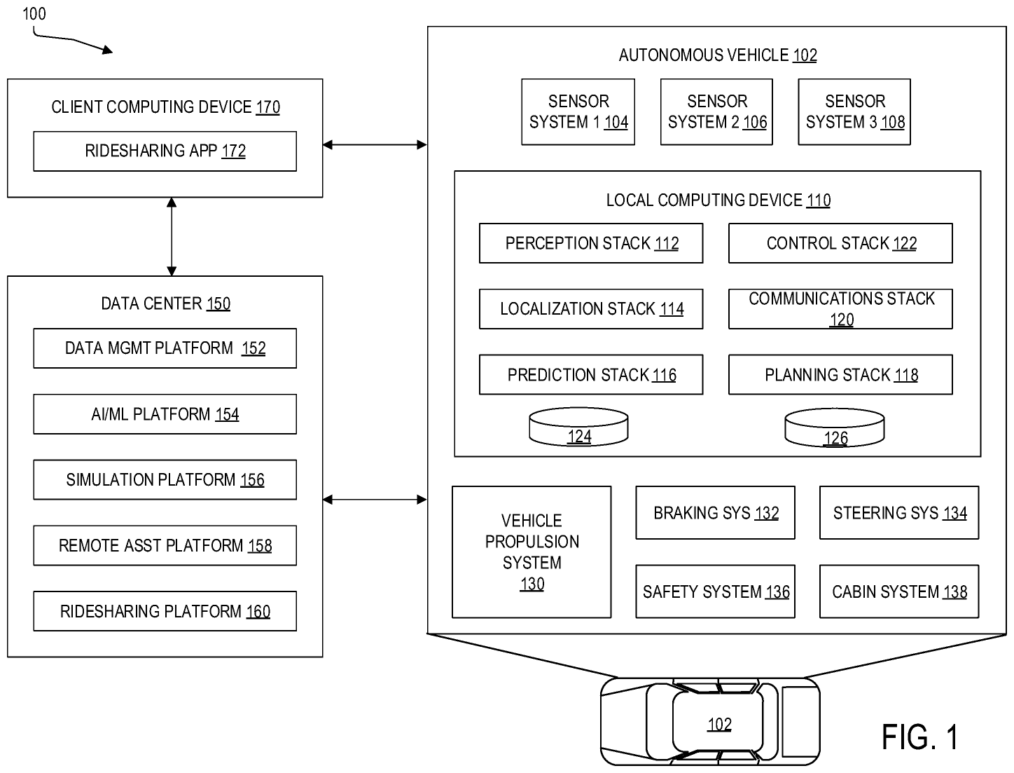

FIG. 1 illustrates an example of an AV management system 100. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include different types of sensors and can be arranged about the AV 102. For instance, the sensor systems 104-108 can comprise Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other embodiments may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some embodiments, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can additionally include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can also identify environmental uncertainties, such as where to look for moving objects, flag areas that may be obscured or blocked from view, and so forth. In some embodiments, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.). The bounding area may by defined on a grid that can be or include a rectangular, cylindrical, or spherical projection of the camera or LIDAR data.

The mapping and localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some embodiments, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some embodiments, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point. In some embodiments, the prediction stack 116 can output a probability distribution of likely paths or positions that the object is predicted to take.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some embodiments, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridesharing platform 160, among other systems.

The data management platform 152 can be or include a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general purpose computing device for accessing the ridesharing application 172. The client computing device 170 can be a customer's mobile computing device or a computing device integrated with the AV 102 (e.g., the local computing device 110). The ridesharing platform 160 can receive requests to pick up or drop off from the ridesharing application 172 and dispatch the AV 102 for the trip.

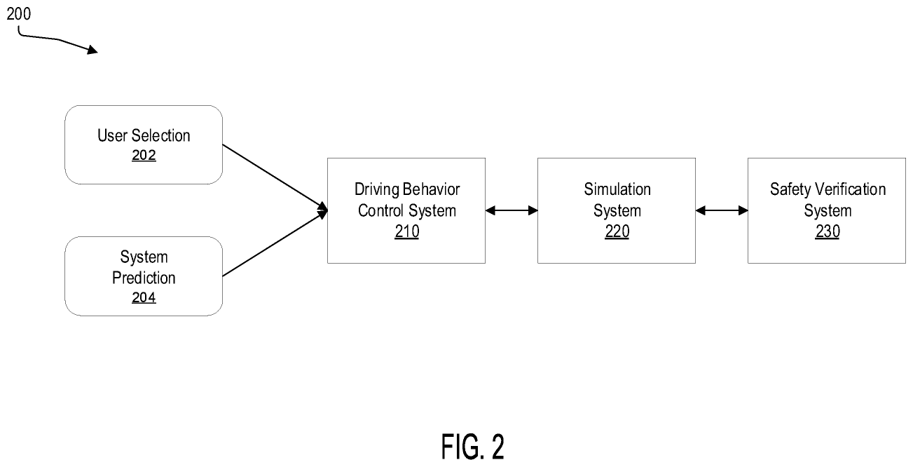

FIG. 2 illustrates an example of an AV control system 200 for customizing an AV driving behavior and verifying the safety of the driving behavior based on a simulation, in accordance with some examples of the present disclosure. In some examples, AV control system 200 can be part of AV management system 100 as illustrated in FIG. 1.

According to some examples, AV control system 200 comprises driving behavior control system 210, simulation system 220, and safety verification system 230. In some examples, driving behavior control system 210 can determine driving parameters (e.g., driving behavior attributes or driving characteristics) based on explicit or implicit input such as user selection 202 and system prediction 204. The driving parameters are associated with an operational driving behavior (e.g., a driving style, etc.) of an AV, for example, whether aggressive or defensive, or comfort or sporty.

Examples of the driving parameters include, but are not limited to, acceleration controls, deceleration controls, speed controls, braking controls, steering controls, suspension controls, power controls, efficiency controls, lighting controls, temperature controls, collision avoidance controls, blind spot information system controls, cruise control controls, lane-keeping controls, navigation controls, electronic driver assistant controls, operation mode controls, signaling controls, climate controls, entertainment system controls, or any other applicable vehicle functions.

In some examples, AV control system 200 can determine the driving parameters to reflect user preferences based on user selection 202 and/or system prediction 204. More specifically, the driving parameters can indicate how an AV drives or operates, for example, maximum/minimum forward/lateral acceleration, maximum/minimum forward/lateral deceleration, maximum/minimum speed, preferred speed range, preferred average speed, maximum/minimum braking, turn radius, steering rotation speed, minimum length of time for lane changes, lane change frequency, etc. In some cases, the driving parameters can specify preferred and/or allowed driving maneuvers/behaviors and/or undesired and/or prohibited driving maneuvers/behaviors (e.g., u-turns, crossing an intersection while the stoplight is yellow, driving on a fast lane of a highway, passing a stopped vehicle, etc.).

Furthermore, the driving parameters can indicate how to calculate routes or navigate. For example, the driving parameters can include prioritizing the fastest time, prioritizing the shortest distance, avoiding a toll, avoiding one-way streets, no freeways, avoiding certain areas (e.g., a construction zone, a school zone, etc.).

In some examples, the driving parameters can be conditional. For example, user preferences can vary depending on the environment. The driving parameters can include one or a combination of weather constraints, date constraints, time of day constraints, vehicle maneuver constraints, speed constraints, traffic constraints, driving zone constraints, road condition constraints, etc. For example, the driving parameters can indicate not accelerating over 50 mph on a rainy day, choosing a sporty mode of operation on weekends or holidays, etc.

While AVs can have pre-programmed driving parameters as default or initial settings, a user can select or modify the driving parameters as preferred. Accordingly, driving behavior control system 210 can determine the driving parameters based on user selection 202 (i.e., explicit user preferences).

In some instances, user selection 202 can be set or provided in any applicable manner. For example, user selection 202 may be set by a user via a user interface on a user device (e.g., mobile devices, smart devices, etc.), a touchscreen of an in-vehicle interface, or in-vehicle voice commands, which allows the user to design or select preferred driving behavior (e.g., driving parameters or characteristics). In some examples, the user can be a passenger or a non-passenger entity that can influence or modify the driving behavior via any applicable manner described above.

According to some examples, AV control system 200 can infer user preferences and predict preferred driving parameters (i.e., system prediction 204) without requiring any user input. In some examples, AV control system 200 can infer system prediction 204 based on sensor data, user data, feedback data, or any other suitable data that may indicate user preferences.

In some instances, system prediction 204 can be based on sensor data, which can be collected from the exterior or interior sensor(s) of the AV. For example, sensor data can indicate that the vehicle is carrying fragile items so that the driving parameters can be adjusted accordingly. In other examples, sensor data can provide whether the user or the passenger is wearing business or casual attire, whether the passenger is in a wheelchair, whether the passenger has a high fever or heart rate, which may indicate a medical condition of the passenger, etc.

Also, system prediction 204 can be based on user data such as user profiles. For example, user profiles can provide age, any disability, weight, height, gender, etc. In other examples, user data can include calendar, events, or appointments information that can indicate the user's pickup location and/or drop-off location. In some instances, user data can indicate multiple passengers. Driving behavior control system 210 can determine the driving parameters accordingly based on system prediction 204 including such user data.

Furthermore, system prediction 204 can be based on feedback data. For example, any feedback that may have been provided by the user from previous driving experience can indicate how the user prefers the AV to operate. For example, if the user feedback indicates that the user felt nauseous while driving at 80 mph on the freeway, system prediction 204 can include user preferences not to drive over 80 mph on freeways.

According to some examples, simulation system 220 can generate a scenario to test the safety of the driving parameters that are determined by driving behavior control system 210. Furthermore, simulation system 220 can perform a simulation of an AV in the scenario to test the safety of the driving parameters. In some examples, simulation system 220 can carry out the same functionalities as simulation platform 156 as illustrated in FIG. 1.

In some examples, simulation system 220 can generate real-world scenarios, which include rendering geospatial information and road infrastructure (e.g., streets, lanes, crosswalks, traffic lights, stop signs, etc.) and simulating varying weather and traffic conditions. The simulation can include, for example, an existing map, AV kinematics, AV behavior, or user behavior.

In some instances, simulation system 220 can perform a simulation of the AV in such scenarios to test how the AV operates under the driving parameters that have been determined by driving behavior control system 210 based on user preferences (e.g., user selection 202 and system prediction 204). In some examples, the simulation can be performed online or offline at a time that is designated by a user. Depending on the complexity and test volume of the driving parameters, the simulation can be completed promptly or take one or two days, in which case the simulation can be done offline overnight.

According to some examples, safety verification system 230 can verify the safety of the driving parameters. In some examples, safety verification system 230 can compare the simulation result with a predetermined safety threshold.

In some examples, the predetermined safety threshold can be based on a human-level safety value to compare against a human driver circumstance. In some instances, the human-level safety value can be derived from a safety performance matrix, which maps the safety of various driving parameters when a vehicle is controlled by a human driver.

In some instances, the predetermined safety threshold is based on safety scores or safety ratings. For example, safety scores can provide the relative safety of the driving parameters that can be based on a risk level, reliability level, etc.

In some examples, the predetermined safety threshold is based on comfort scores. Comfort scores can provide a level of comfort or discomfort based on the driving parameters. In some instances, the comfort scores can be derived from user feedback (e.g., whether the user has felt motion sickness under certain circumstances). Also, user feedback can be a scaled value (e.g., from 0 to 10 with 10 being the most comfortable) under varying environments.

According to some examples, for ease of comparison, safety verification system 230 can convert the simulation result into a numeric value, rating scale, or any applicable scale that can be compared against the predetermined safety threshold. For example, the simulation result can be scaled into a numeric value, e.g., from 0 to 10 with 10 being the most dangerous or most prone to an accident.

If the simulation result is equal to or above the predetermined safety threshold, safety verification system 230 can determine that the driving parameters have passed the safety test and confirm the safe operation of an AV under the driving parameters.

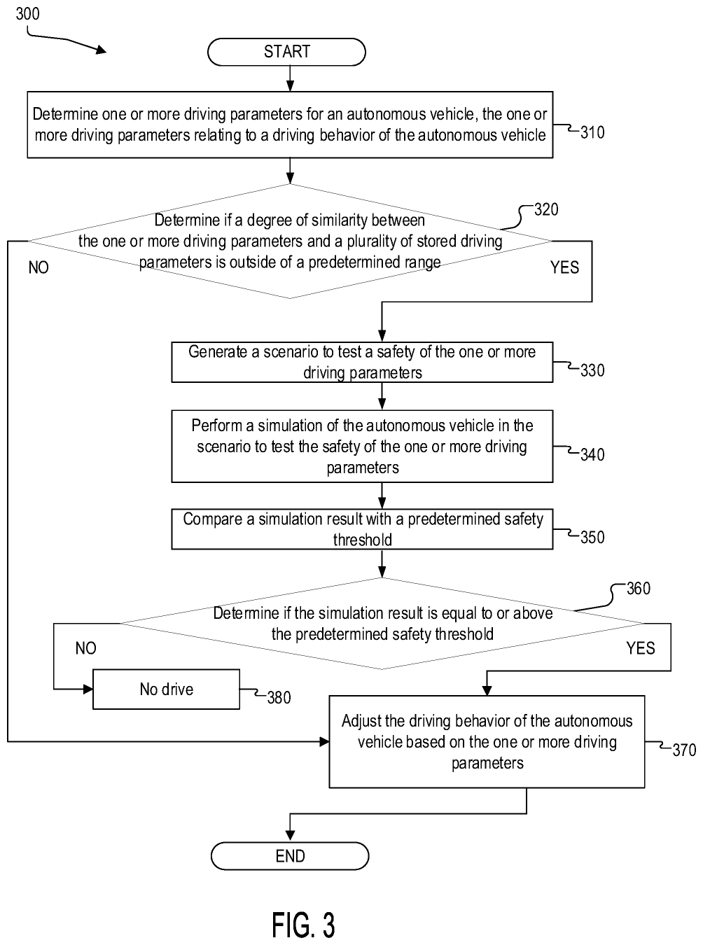

FIG. 3 is a flowchart of an example method 300 for verifying the safety of an AV driving behavior based on a simulation according to some aspects of the disclosed technology. Although example method 300 depicts a particular sequence of operations, the sequence may be altered without departing from the scope of the present disclosure. For example, some of the operations depicted may be performed in parallel or in a different sequence that does not materially affect the function of method 300. In other examples, different components of an example device or system that implements the method 300 may perform functions at substantially the same time or in a specific sequence.

According to some examples, at step 310, AV management system can determine one or more driving parameters for an AV. The one or more driving parameters are related to the driving behavior of the AV (e.g., driving style). For example, driving behavior control system 210 as illustrated in FIG. 2 can determine one or more driving parameters that are related to the driving behavior of AV 102 as illustrated in FIG. 1.

In some examples, the driving parameters are determined based on explicit user input or implicit system prediction. For example, as illustrated in FIG. 2, driving behavior control system 210 can determine the driving parameters based on user selection 202 and/or system prediction 204.

In some instances, AVs can have pre-programmed driving parameters as default or initial settings. Based on the one or more driving parameters determined by the AV management system, the pre-programmed driving parameters can be modified to better suit user preferences.

In some examples, the AV management system determines the driving parameter(s) based on a user selection and/or system prediction. In some instances, the AV management system can set the initial setting for the driving behavior based on system prediction, for example, prior to interacting with the user or being provided with a user-selected setting and adjust the driving parameters based on user selection.

As previously described, the driving parameters can include, but are not limited to, acceleration controls, deceleration controls, speed controls, braking controls, steering controls, suspension controls, power controls, efficiency controls, lighting controls, temperature controls, signaling controls, climate controls, entertainment system controls, operation mode controls, or any other applicable vehicle functions.

In some examples, based on various selections of the one or more driving parameters, driving behavior of the AV can be determined, for example, whether aggressive vs. defensive, comfort vs. sporty, etc.

In some instances, the one or more driving parameters or the driving behavior can be conditional. For example, the driving parameters can include weather constraints, date constraints, time of day constraints, vehicle maneuver constraints, speed constraints, traffic constraints, driving zone constraints, road condition constraints, or any suitable constraints as preferred.

According to some examples, at step 320, AV management system can determine a degree of similarity between the one or more driving parameters and a plurality of stored driving parameters. For example, driving behavior control system 210 as illustrated in FIG. 2 can compare the one or more driving parameters with a plurality of driving parameters that are stored in a database (e.g., AV operational database 124 as illustrated in FIG. 1 or a remote database). The plurality of driving parameters stored in the database has been validated for safety (i.e., have passed the safety test). For example, the safety of the plurality of driving parameters stored in the database has been verified based on a simulation in a similar manner as described in FIG. 2.

Based on the comparison, driving behavior control system 210 as illustrated in FIG. 2 can determine a degree of similarity between the one or more driving parameters and the plurality of stored driving parameters. If the driving parameter is a number, the degree of similarity can be calculated based on absolute difference |x−y| or squared difference (x−y)\hat{ }2 between a driving parameter and a stored driving parameter. For example, if the speed constraint is 10, and the stored speed constraint is 20, the difference may be calculated as |10−20|=10. Alternative or more advanced distance metrics can also be used as a function, f(x, y), where f is a general function. If the driving parameter is a boolean (truth) value, the degree of similarity can be calculated based on the equality of the driving parameter and the stored driving parameter. For example, if the driving parameter and stored driving parameter are the same, the degree of similarity for the driving parameter is set to a high value. If the driving parameter and stored driving parameter are different, the degree of similarity for the driving parameter is set to a low value. For multiple driving parameters, the degree of similarity of the set of driving parameters can be calculated as a weighted sum or multiple of the degree of similarity of each individual driving parameter.

If the degree of similarity between the one or more driving parameters and the plurality of stored driving parameters is within the predetermined range, the AV management system can bypass the safety test based on a simulation and proceed to adjust the driving behavior of the AV based on the one or more driving parameters at step 370. The predetermined range for each driving parameter can be calculated by analyzing the sensitivity of that driving parameter to the safety scores and choosing the driving parameter range that will likely produce an acceptable safety score within a probability margin (for example 95% probability or 99% probability). Analysis of the sensitivity can be achieved by performing a statistical analysis on a set of past safety results (for example, all previous simulation results). Analysis of the sensitivity may also be performed by perturbing the driving parameters and running the safety tests on the perturbed driving parameters. In some examples, the predetermined range can be based on a level of safety (e.g., safety scores) relating to the driving parameters. For example, the predetermined range for an average speed on freeways can be set as plus/minus 2 mph. If the driving parameters to be tested for safety includes maintaining an average speed at 68 mph and the stored driving parameters include an average speed at 70 mph, part of the driving parameters relating to maintaining the average speed at 68 mph can skip the safety test based on a simulation. In this case, the AV management system can accept the driving parameter of maintaining the average speed at 68 mph and adjust the driving behavior accordingly.

On the other hand, if the degree of similarity between the one or more driving parameters and the plurality of stored driving parameters is outside of a predetermined range, method 300 can proceed to step 330 for testing the safety of the one or more driving parameters.

At step 330, AV management system can generate a scenario to test the safety of the one or more driving parameters. For example, simulation system 220 as illustrated in FIG. 2 or simulation platform 156 as illustrated in FIG. 1 generates a scenario to test the safety of the one or more driving parameters. The scenario is designed to determine the safety and reliability of how the AV operates based on the one or more driving parameters.

In some examples, the scenario is generated based on past drives. For example, simulation system 220 as illustrated in FIG. 2 can generate the scenario based on past drives that involve similar driving parameters (e.g., same conditions/constraints or same controls, etc.).

In some instances, the scenario is generated based on existing or upcoming drives. For example, simulation system 220 as illustrated in FIG. 2 can generate the scenario based on current or upcoming drives to verify the safety of the one or more driving parameters prior to proceeding towards the existing or upcoming trips.

In some examples, the scenario is generated based on other scenarios based on a simulation. For example, simulation system 220 as illustrated in FIG. 2 can generate the scenario based on other scenarios that are generated for a simulation.

At step 340, AV management system can perform a simulation of the AV in the scenario to test the safety of the one or more driving parameters. For example, simulation platform 156 as illustrated in FIG. 1 or simulation system 220 as illustrated in FIG. 2 can perform a simulation of the AV in the scenario to test the safety of the one or more driving parameters.

In some examples, the simulation can be performed online or offline. In some instances, the simulation can be scheduled ahead based on the complexity and the test volume of the driving parameters so that the simulation can be completed prior to initiation of the AV operation.

At step 350, AV management system can compare a simulation result with a predetermined safety threshold. For example, safety verification system 230 can compare the simulation result with a predetermined safety threshold. In some examples, the predetermined safety threshold is based on a human-level safety value, safety scores, and/or comfort scores.

At step 360, AV management system can determine if the simulation result is equal to or above the predetermined safety threshold. According to some examples, the simulation result can be converted and scaled into a numeric value to compare against a predetermined safety threshold. For example, safety verification system 230 can convert the simulation result into a numeric value.

Based on a determination that the simulation result is equal to or above the predetermined safety threshold, AV management system can adjust the driving behavior of the AV based on the one or more driving parameters at step 370. For example, if the simulation result is equal to or above the predetermined safety threshold, AV management system 100 as illustrated in FIG. 1 can adjust the driving behavior of the AV based on the driving parameters that have passed the safety test at step 360.

In some examples, the AV management system can adjust ranking on paths in planning, planning algorithm, operation of sensors (whether or when to turn on/off), frequency of lidar or radar sensors, or physical bounds of processing of objects based on the safety-verified driving parameters.

If the simulation result is below the predetermined safety threshold, the AV management system does not proceed with the operation of the AV at step 380. For example, if the simulation result is below the predetermined safety threshold, safety verification system 230 determines that the driving parameters fail the safety test and AV management system 100 does not modify the driving parameters. For example, the driving parameters return to default or initial settings.

According to some examples, method 300 comprises generating a report including the simulation result associated with the one or more driving parameters. For example, AV management system 100 as illustrated in FIG. 1 or safety verification system 230 as illustrated in FIG. 2 can generate a report including the simulation result as performed by simulation system 220. In some examples, the report can specify the one or more driving parameters that have been tested, details of the scenario in the simulation, how the AV reacts or operates, etc. The report can include a comparison between the simulation result of the one or more driving parameters and simulation results from other tests, for example, previous tests for similar driving parameters that involve same or similar constraints, controls, or functionalities of the AV. The report can also include a comparison between the simulation result based on the modified driving parameters and how the AV operates under the initial settings (e.g., pre-programmed or default driving parameters).

According to some examples, method 300 further comprises storing the one or more driving parameters in a user profile. For example, AV management system 100 as illustrated in FIG. 1 or AV control system 200 as illustrated in FIG. 2 can store the driving parameters in a user profile linked to a particular user so that any vehicle with the particular user can automatically utilize the stored driving parameters without having to require the user to reselect them. In some examples, the driving parameters can be stored in the user profile, which can be accessed via any vehicle in the same vehicle fleet.

In some examples, the driving parameters can be stored in the user profile as a set. Further, various sets can be stored for a particular user so that the user can choose from the various sets on different occasions.

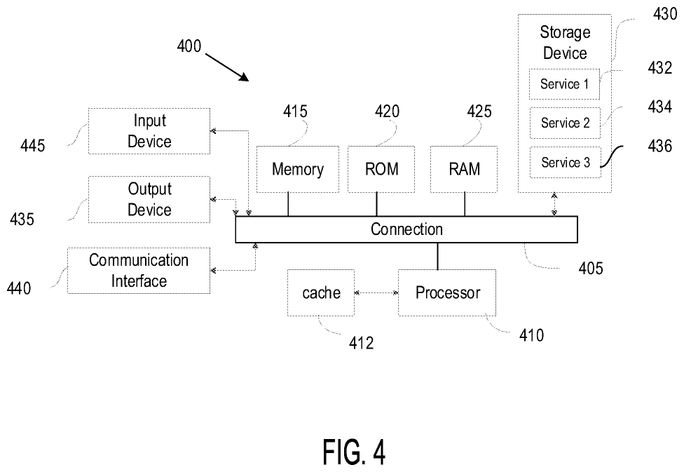

FIG. 4 shows an example of computing system 400, which can be for example any computing device making up AV management system 100 or AV control system 200, or any component thereof in which the components of the system are in communication with each other using connection 405. Connection 405 can be a physical connection via a bus, or a direct connection into processor 410, such as in a chipset architecture. Connection 405 can also be a virtual connection, networked connection, or logical connection.

In some embodiments, computing system 400 is a distributed system in which the functions described in this disclosure can be distributed within a data center, multiple data centers, a peer network, etc. In some embodiments, one or more of the described system components represents many such components each performing some or all of the function for which the component is described. In some embodiments, the components can be physical or virtual devices.

Example system 400 includes at least one processing unit (CPU or processor) 410 and connection 405 that couples various system components including system memory 415, such as read-only memory (ROM) 420 and random-access memory (RAM) 425 to processor 410. Computing system 400 can include a cache of high-speed memory 412 connected directly with, in close proximity to, or integrated as part of processor 410.

Processor 410 can include any general purpose processor and a hardware service or software service, such as services 432, 434, and 436 stored in storage device 430, configured to control processor 410 as well as a special-purpose processor where software instructions are incorporated into the actual processor design. Processor 410 may essentially be a completely self-contained computing system, containing multiple cores or processors, a bus, memory controller, cache, etc. A multi-core processor may be symmetric or asymmetric.

To enable user interaction, computing system 400 includes an input device 445, which can represent any number of input mechanisms, such as a microphone for speech, a touch-sensitive screen for gesture or graphical input, keyboard, mouse, motion input, speech, etc. Computing system 400 can also include output device 435, which can be one or more of a number of output mechanisms known to those of skill in the art. In some instances, multimodal systems can enable a user to provide multiple types of input/output to communicate with computing system 400. Computing system 400 can include communications interface 440, which can generally govern and manage the user input and system output. There is no restriction on operating on any particular hardware arrangement, and therefore the basic features here may easily be substituted for improved hardware or firmware arrangements as they are developed.

Storage device 430 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 430 can include software services, servers, services, etc., that when the code that defines such software is executed by the processor 410, it causes the system to perform a function. In some embodiments, a hardware service that performs a particular function can include the software component stored in a computer-readable medium in connection with the necessary hardware components, such as processor 410, connection 405, output device 435, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A method comprising:
determining one or more driving parameters for an autonomous vehicle, the one or more driving parameters relating to a driving behavior of the autonomous vehicle;
determining a degree of similarity between the one or more driving parameters and a plurality of stored driving parameters;
based on a determination that the degree of the similarity is outside of a predetermined range, generating a scenario to test a safety of the one or more driving parameters;
performing a simulation of the autonomous vehicle in the scenario to test the safety of the one or more driving parameters;
comparing a simulation result with a predetermined safety threshold; and
based on a determination that the simulation result is equal to or above the predetermined safety threshold, adjusting the driving behavior of the autonomous vehicle based on the one or more driving parameters.

2. The method of claim 1, further comprising:
generating a report including the simulation result associated with the one or more driving parameters.

3. The method of claim 1, further comprising:
storing the one or more driving parameters in a user profile.

4. The method of claim 1, wherein the one or more driving parameters are determined based on a user selection.

5. The method of claim 1, wherein the one or more driving parameters are determined based on a prediction, wherein the prediction is based on at least one of a combination of sensor data, user data, and feedback data.

6. The method of claim 1, wherein the predetermined safety threshold is based on at least one of a human-level safety value, one or more safety scores, and one or more comfort scores.

7. The method of claim 1, wherein the driving behavior is associated with at least one of acceleration controls, deceleration controls, speed controls, braking controls, steering controls, suspension controls, power controls, efficiency controls, lighting controls, temperature controls, signaling controls, climate controls, entertainment system controls, and operation mode controls.

8. The method of claim 1, wherein the one or more driving parameters include at least one of weather constraints, date constraints, time of day constraints, vehicle maneuver constraints, speed constraints, driving zone constraints, road condition constraints, and traffic constraints.

9. A system comprising:
one or more processors; and
a computer-readable medium comprising instructions stored therein, which when executed by the one or more processors, cause the one or more processors to:
determine one or more driving parameters for an autonomous vehicle, the one or more driving parameters relating to a driving behavior of the autonomous vehicle;
determine a degree of similarity between the one or more driving parameters and a plurality of stored driving parameters;
based on a determination that the degree of the similarity is outside of a predetermined range, generate a scenario to test a safety of the one or more driving parameters;
perform a simulation of the autonomous vehicle in the scenario to test the safety of the one or more driving parameters;
compare a simulation result with a predetermined safety threshold; and
based on a determination that the simulation result is equal to or above the predetermined safety threshold, adjust the driving behavior of the autonomous vehicle based on the one or more driving parameters.

10. The system of claim 9, wherein the instructions, which when executed by the one or more processors, further cause the one or more processors to:
generate a report including the simulation result associated with the one or more driving parameters.

11. The system of claim 9, wherein the instructions, which when executed by the one or more processors, further cause the one or more processors to:
store the one or more driving parameters in a user profile.

12. The system of claim 9, wherein the one or more driving parameters are determined based on a user selection.

13. The system of claim 9, wherein the one or more driving parameters are determined based on a prediction, wherein the prediction is based on at least one of a combination of sensor data, user data, and feedback data.

14. The system of claim 9, wherein the predetermined safety threshold is based on at least one of a human-level safety value, one or more safety scores, and one or more comfort scores.

15. A non-transitory computer-readable storage medium comprising computer-readable instructions, which when executed by a computing system, cause the computing system to:
determine one or more driving parameters for an autonomous vehicle, the one or more driving parameters relating to a driving behavior of the autonomous vehicle;
determine a degree of similarity between the one or more driving parameters and a plurality of stored driving parameters;
based on a determination that the degree of the similarity is outside of a predetermined range, generate a scenario to test a safety of the one or more driving parameters;
perform a simulation of the autonomous vehicle in the scenario to test the safety of the one or more driving parameters;
compare a simulation result with a predetermined safety threshold; and
based on a determination that the simulation result is equal to or above the predetermined safety threshold, adjust the driving behavior of the autonomous vehicle based on the one or more driving parameters.

16. The non-transitory computer-readable storage medium of claim 15, wherein the instructions, which when executed by the computing system, further cause the computing system to:
generate a report including the simulation result associated with the one or more driving parameters.

17. The non-transitory computer-readable storage medium of claim 15, wherein the instructions, which when executed by the computing system, further cause the computing system to:
store the one or more driving parameters in a user profile.

18. The non-transitory computer-readable storage medium of claim 15, wherein the one or more driving parameters are determined based on a user selection.

19. The non-transitory computer-readable storage medium of claim 15, wherein the one or more driving parameters are determined based on a prediction, wherein the prediction is based on at least one of a combination of sensor data, user data, and feedback data.

20. The non-transitory computer-readable storage medium of claim 15, wherein the predetermined safety threshold is based on at least one of a human-level safety value, one or more safety scores, and one or more comfort scores.
